(19) United States
(12) Patent Application Publication
(10) Pub. No.: US 2026/0157389 A1
(43) Pub. Date: Jun. 11, 2026

(54) Feed bar assembly

(71) Applicant: TNA Australia Pty Limited, Sydney (AU)

(72) Inventors: Morey James Hakim, Sydney (AU); Robert Erich Fritz, Sydney (AU)

(21) Appl. No.: 19/407,427

(22) Filed: Dec. 3, 2025

(30) Foreign Application Priority Data
Dec. 10, 2024 (AU) 2024904087

(51) Int. Cl. A23G 3/34

(52) U.S. Cl. CPC A23G 3/0036

(57) ABSTRACT

There is disclosed herein a feed bar assembly for a confectionery moulding machine, the feed bar assembly including: a first feed bar set having a pair of elongated feed bars, with each elongated feed bar including a plurality of lugs, the first feed bar set being moveable between a raised position to engage one or more confectionery moulding trays and a lowered position to disengage from the one or more confectionery moulding trays; a second feed bar set having a pair of elongated feed bars, with each elongated feed bar including a plurality of lugs, the second feed bar set being moveable between a raised position to engage one or more confectionery moulding trays and a lowered position to disengage from the one or more confectionery moulding trays; a feed bar lift adapted to move the first and second feed bar sets between the respective raised and lowered positions.

### CROSS-REFERENCE TO RELATED APPLICATION

This application claims priority to Australian Patent Application No. 2024904087, filed on Dec. 10, 2024. The entire disclosure of Australian Patent Application No. 2024904087 is hereby incorporated by reference in its entirety and for all purposes.

### FIELD

The present disclosure generally relates to confectionery moulding machines, and more particularly, but not exclusively, to feed bar assemblies for confectionery moulding machines and methods of operating the same.

### BACKGROUND

In the production of confectionery items, the operation of a confectionery moulding machine (starch mogul) typically involves the filling of confectionery trays with starch and forming impressions in the starch. The impressions provide a plurality of cavities, and liquid is delivered to the cavities to form the confectionery when set.

The industry standard to move (index) the trays throughout a confectionery moulding machine is to provide a set or pair of feed bars, whereby the feed bars perform, in sequence, the actions of: a) pushing the trays from a first position to a second position by a set distance; b) disengaging the trays; c) returning to the first position; d) reengaging the trays; and e) pushing again. The return stroke of such feed bars is required to be as fast as possible to avoid “dead time” (i.e. where the trays are stationary) and to move a high number of trays per minute. Accordingly, such known mechanisms require an aggressive feed bar acceleration and deceleration profile, causing shocks and vibrations that are transferred to the trays, which in turn lead to cracks in the starch moulded shapes. Known mechanisms may also have reduced precision and accuracy in positioning the trays, thereby leading to tray misalignment during the confectionery moulding process.

### SUMMARY

It is an object of the present invention to substantially overcome, or at least ameliorate, one or more of the disadvantages of existing arrangements, or at least provide a useful alternative to existing arrangements.

There is disclosed herein a feed bar assembly for a confectionery moulding machine, the feed bar assembly including:
a first feed bar set having a pair of elongated feed bars, with each elongated feed bar including a plurality of lugs, the first feed bar set being moveable between a raised position to engage one or more confectionery moulding trays and a lowered position to disengage from the one or more confectionery moulding trays;
a second feed bar set having a pair of elongated feed bars, with each elongated feed bar including a plurality of lugs, the second feed bar set being moveable between a raised position to engage one or more confectionery moulding trays and a lowered position to disengage from the one or more confectionery moulding trays;
a feed bar lift adapted to move the first and second feed bar sets between the respective raised and lowered positions.

In one or more embodiments, the feed bar lift moves the first feed bar set from the lowered position to the raised position whilst simultaneously moving the second feed bar set from the raised position to the lowered position.

In one or more embodiments, the first feed bar set is movable in a first direction from a start position to an end position to complete a first full stroke. In such embodiments, the second feed bar set is movable in a second direction that is opposite to the first direction. In such embodiments, the first feed bar set is movable at a distance that corresponds to a distance at which the second feed bar set moves.

In one or more embodiments, the first feed bar set is lowered following the completion of the first full stroke whilst the second feed bar set is raised.

In one or more embodiments, the second feed bar set is movable in a first direction from a start position to an end position to complete a second full stroke. In such embodiments, the first feed bar set is movable in a second direction that is opposite to the first direction. In such embodiments, the second feed bar set is movable at a distance that corresponds to a distance at which the first feed bar set moves.

In one or more embodiments, the second feed bar set is lowered following the completion of the second full stroke whilst the first feed bar set is raised to commence the first full stroke to continue a movement profile of the feed bar assembly.

In one or more embodiments, the first and second feed bar sets are locatable below the one or more confectionery moulding trays of the confectionery moulding machine.

In one or more embodiments, the first feed bar set is locatable at a first side of the one or more confectionery moulding trays and the second feed bar set is locatable at a second side of the one or more confectionery moulding trays.

In one or more embodiments, the first and second feed bar sets are locatable above the one or more confectionery moulding trays of the confectionery moulding machine.

There is also disclosed herein a method of operating a feed bar assembly for a confectionery moulding machine, the feed bar assembly including a first feed bar set and a second feed bar set, the method including the steps of:
moving the first feed bar set from a lowered position to a raised position to engage one or more confectionery moulding trays whilst simultaneously moving the second feed bar set from a raised position to a lowered position;
moving the first feed bar set in a first direction from a start position to an end position to complete a first full stroke;
moving the first feed bar set from the raised position to the lowered position to disengage the one or more confectionery moulding trays whilst simultaneously moving the second feed bar set from a lowered position to a raised position to engage one or more of the confectionery moulding trays; and
moving the second feed bar set in the first direction from a start position to an end position to complete a second full stroke.

There is also disclosed herein a feed bar assembly for a confectionery moulding machine, the feed bar assembly including:
a first feed bar set having a pair of elongated feed bars, with each elongated feed bar including a plurality of lugs, the first feed bar set being moveable between a first position to engage one or more confectionery moulding trays and a second position to disengage from the one or more confectionery moulding trays;
a second feed bar set having a pair of elongated feed bars, with each elongated feed bar including a plurality of lugs, the second feed bar set being moveable between a first position to engage one or more confectionery moulding trays and a second position to disengage from the one or more confectionery moulding trays;
a feed bar mover adapted to move the first and second feed bar sets between the respective first and second positions.

In one or more embodiments, in the first position, the feed bars of the first feed bar set are closer to a tray line relative to the feed bars of the second feed bar set and in the second position, the feed bars of the second feed bar set are closer to the tray line relative to the feed bars of the first feed bar set. In such embodiments, the feed bar mover moves the first feed bar set from the second position to the first position whilst simultaneously moving the second feed bar set from the first position to the second position.

### BRIEF DESCRIPTION OF THE DRAWINGS

For a more complete understanding of the present invention, exemplary embodiments of the invention are explained in more detail in the following description with reference to the accompanying drawing figures, in which like reference signs designate like parts and in which:

FIGS. 1 to 4 are schematic side views of a feed bar assembly according to one embodiment, showing various stages of a movement profile;

FIGS. 5 to 8 are schematic side views of the feed bar assembly shown in FIGS. 1 to 4, showing various stages of a subsequent movement profile; and

FIG. 9 is schematic end view of the feed bar assembly shown in FIGS. 1 to 4;

FIG. 10 is a schematic end view of the feed bar assembly shown in FIGS. 5 to 8;

FIG. 11 is a schematic top view of a feed bar assembly according to another embodiment, showing various stages of a movement profile;

FIG. 12 is a schematic top view of the feed bar assembly shown in FIG. 11, showing various stages of a subsequent movement profile; and

FIG. 13 is schematic end view of the feed bar assembly shown in FIG. 11; and

FIG. 14 is a schematic end view of the feed bar assembly shown in FIG. 12.

### DETAILED DESCRIPTION

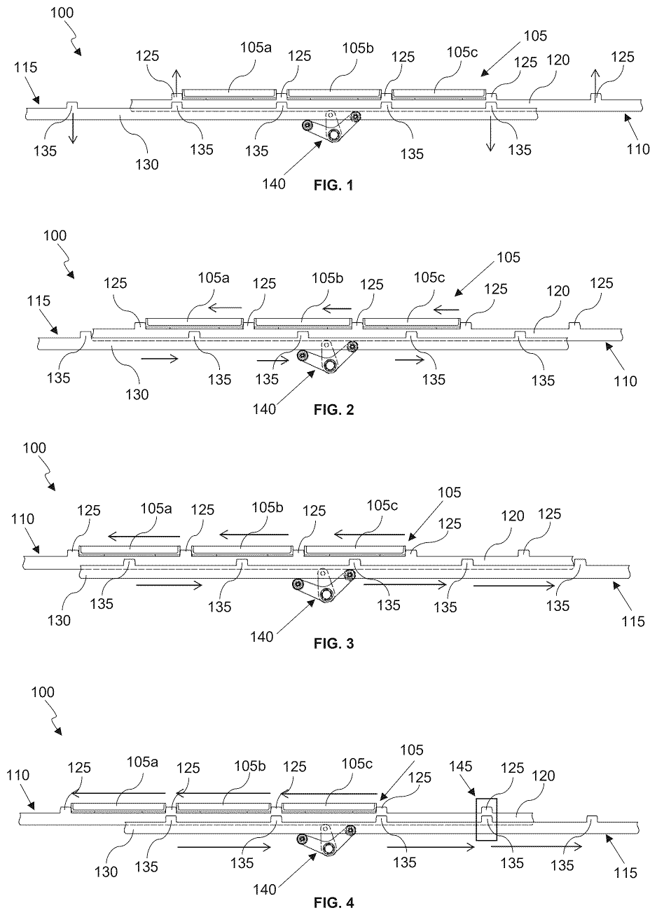

In FIGS. 1 to 8 of the accompanying drawings, there is schematically depicted an embodiment of a feed bar assembly or system 100 for a confectionery moulding machine (not shown). The feed bar assembly 100 is incorporated in the machine, and during a typical operation of the machine, a plurality of trays (confectionery moulding trays) 105 are moved around (indexed) to accommodate various stages of a confectionery moulding process.

In the depicted embodiment, the feed bar assembly 100 and various components thereof are located below the plurality of trays 105 and may thus engage the trays 105 from below. It is, however, envisaged that in other embodiments, one or more components of the feed bar assembly 100 are locatable at the side(s) of the trays 105 so as to engage the trays 105 from the side. In other embodiments, one or more components of the feed bar assembly 100 may alternatively be locatable at the top of the trays 105 so as to engage the trays 105 from the top.

It will also be understood that the various components of the feed bar assembly 100 may be controlled by way of one or more central processing units (not shown) associated with the confectionery moulding machine or its sub-assemblies. The various components of the feed bar assembly 100 may also otherwise be supported by or otherwise operatively associated with various components of the confectionery moulding machine. It will also be appreciated that the feed bar assembly 100 and various embodiments thereof may be incorporated or retrofitted to existing confectionery moulding machines.

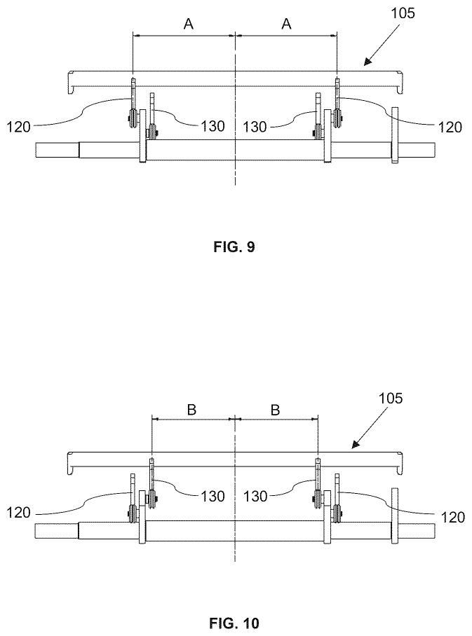

The feed bar assembly 100 in the depicted embodiment includes at least two feed bar sets or pairs, i.e. a first feed bar set 110 and a second feed bar set 115. The first feed bar set 110 includes a pair of elongated feed bars 120 each having a plurality of feed bar lugs 125, and the second feed bar set 115 likewise includes a pair of elongated feed bars 130 each having a plurality of feed bar lugs 135. In the interest of clarity, only one of the elongated feed bars from each of the feed bar sets 110, 115 are visible in FIGS. 1 to 8 (being side views of the feed bar assembly 100). An illustration of the pair of elongated feed bars 120, 130 of the respective first and second feed bar sets 110, 115 is shown in FIGS. 9 and 10 (being end views of the feed bar assembly 100). As shown in FIG. 9, the elongated feed bars 120 of the first feed bar set 110 are spaced from a centre line (i.e. the “tray line”) by the same distance (i.e. distance A) and likewise, as shown in FIG. 10, the elongated feed bars 130 of the second feed bar set 115 are spaced from the centre line by the same distance (i.e. distance B). In other words, the elongated feed bars 120 of the first feed bar set 110 are spaced from another by a first distance and the elongated feed bars 130 of the second feed bar set 115 are spaced from another by a second distance and in a preferred form, the first distance is larger than the second distance. The elongated feed bars 120 and 130 on each side are also spaced apart from one another by a distance to allow for the reciprocating movement of the first and second feed bar sets 110, 115.

In the embodiment shown, the feed bar lugs 125 each project in an upward direction from the elongated feed bar 120, and are spaced apart along the elongated feed bar 120 by a length or distance that corresponds to a length of each tray 105. Accordingly, the feed bar lugs 125 may engage a front and/or rear portion of the tray 105 whilst the tray 105 is situated on a length of the elongated feed bar 120 between two of the lugs 125. Likewise, the feed bar lugs 135 each project in an upward direction from the elongated feed bar 130, and are spaced apart along the elongated feed bar 130 by a length or distance that corresponds to a length of each tray 105. Accordingly, the feed bar lugs 135 may engage a front and/or rear portion of the tray 105 whilst the tray 105 is situated on a length of the elongated feed bar 130 between two of the lugs 135. In other embodiments, the feed bar lugs 125 may each project transversely from the elongated feed bar 120 or in any other direction relative to the elongated feed bar 120.

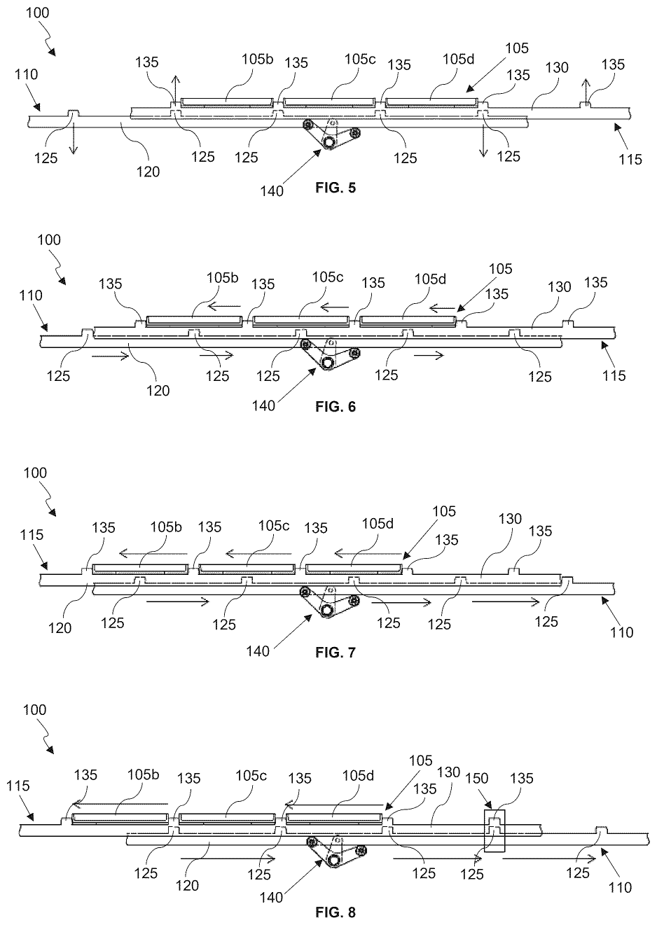

In FIGS. 1 to 4, three trays 105a, 105b, 105c are shown, by way of example only, in association with a section of the first feed bar set 110 at different stages of a full stroke (as will be described in further detail below). In FIGS. 5 to 8, three trays 105b, 105c, 105d are shown, again by way of example only, in association with a section of the second feed bar set 115 at different stages of a full stroke. It will be understood that each full stroke may represent a portion of the continuous movement profile of the feed bar assembly 100. It will be understood that the trays 105a, 105b, 105c, and 105d are merely shown for ease of illustration of the relative movement/positions of the first feed bar set 110 and the second feed bar set 115, and in reality, the feed bar assembly 100 may operate in the same manner regardless of the number of trays 105 present. In the Figures, each feed bar set 110, 115 is shown with five feed bar lugs 125 and 135, respectively. It will be understood that the number and/or configuration of the feed bar lugs 125 and 135 are not necessarily limited to the number and/or configuration as shown in the drawings or described above, and may be adjusted depending on the design requirements of the confectionery moulding machine.

In FIGS. 1 to 4, four stages of a first full stroke of the feed bar assembly 100 are shown, and in FIGS. 5 to 8, four stages of a second full stroke of the feed bar assembly 100 are shown, with the first and second strokes illustrating a reciprocating arrangement between the first and second feed bar sets 110, 115. It will be appreciated that the stages are shown to merely illustrate the relative movements/positions of the first feed bar set 110 and the second feed bar set 115 in each full stroke.

In the first full stroke as shown in FIGS. 1 to 4, the first feed bar set 110 is shown to be in a raised position relative to the second feed bar set 115. Conversely, in the second full stroke as shown in FIGS. 5 to 8, the first feed bar set 110 is shown to be in a lowered position relative to the second feed bar set 115. The raising or lowering of the first and second feed bar sets 110, 115 may be facilitated by a single feed bar lift or mover 140, which may be controlled to drive the movement of the first and second feed bar sets 110, 115 at the same time. It will, however, be appreciated that in other embodiments (not shown), each feed bar set 110, 115 may be operatively associated with a dedicated feed bar lift/drive unit for independent control. The feed bar lift 140 and various embodiments thereof may be locatable at any position relative to the feed bar sets 110 and 115, depending on the design requirements of the confectionery moulding machine.

In the first full stroke as shown in FIGS. 1 to 4, the first feed bar set 110 engages the trays 105a, 105b, 105c and moves in a first direction from a start position (FIG. 1) to an end position (FIG. 4). In the Figures, this first direction is from the right to the left, although it will be understood that this first direction may also be considered a forward direction. It will be understood that the trays 105a, 105b, 105c move with the first feed bar set 110 during this first full stroke. Conversely, in this first full stroke as shown in FIGS. 1 to 4, the second feed bar set 115 (which is in a lowered position relative to the first feed bar set 110 and thus not engaging the trays) is shown to move in a second direction that is opposite to the first direction. In the Figures, this second direction is from the left to the right although it will be understood that this first direction may also be considered a rearward direction. It will be understood that the first feed bar set 110 moves in the first direction at a distance that corresponds to a distance at which the second feed bar set 115 moves in the second direction. In other words, upon the completion of the first full stroke as shown in FIGS. 1 to 4, the first feed bar set 110 has moved from right to left along the same distance/rate that the second feed bar set 115 has moved from left to right. This distance may correspond to a length of a tray and a gap between the trays.

Following the completion of the first full stroke as shown in FIGS. 1 to 4, the feed bar lugs 125 of the first feed bar set 110 and the feed bar lugs 135 of the second feed bar set 115 are aligned (see, for example, box 145 in FIG. 4). In FIG. 4, the first feed bar set 110 is shown to be in the end position whilst the second feed bar set 115 is in a position that corresponds to the start position of the first feed bar set 110 shown in FIG. 1. The second full stroke may commence immediately after the first full stroke.

In the second full stroke as shown in FIGS. 5 to 8, the feed bar lift 140 is controlled or actuated to lower the first feed bar set 110 and raise the second feed bar set 115, whereby the first feed bar set 110 disengages the trays 105a, 105b, 105c and the second feed bar set 115 engages the trays 105b, 105c, 105d. The second feed bar set 115 moves in the first direction from a start position (FIG. 5) to an end position (FIG. 8). As discussed above, this first direction is from the right to the left in the Figures, although it will be understood that this first direction may also be considered a forward direction. It will be understood that the trays 105b, 105c, 105d move with the second feed bar set 115 during this first full stroke. Conversely, in this second full stroke as shown in FIGS. 5 to 8, the first feed bar set 110 (which is in a lowered position relative to the second feed bar set 115 and thus not engaging the trays) is shown to move in the second direction that is opposite to the first direction. As discussed above, this second direction is from the left to the right in the Figures, although it will be understood that this first direction may also be considered a rearward direction. As with the first full stroke discussed above, it will be understood that in the second full stroke, the second feed bar set 115 moves in the first direction at a distance that corresponds to a distance at which the first feed bar set 110 moves in the second direction. In other words, upon the completion of the second full stroke as shown in FIGS. 5 to 8, the second feed bar set 115 has moved from right to left along the same distance/rate that the first feed bar set 110 has moved from left to right. As discussed above, this distance may correspond to a length of a tray and a gap between the trays.

Following the completion of the second full stroke as shown in FIGS. 5 to 8, the feed bar lugs 125 of the first feed bar set 110 and the feed bar lugs 135 of the second feed bar set 115 are aligned (see, for example, box 150 in FIG. 8). The feed bar lift 140 may then be controlled to raise the first feed bar set 110 and lower the second feed bar set 115, whereby the first full stroke as shown in FIGS. 1 to 4 may commence again to continue the movement profile of the feed bar assembly 100.

It is envisaged that the raising and lowering of the first feed bar set 110 and the second feed bar set 115 may either be simultaneously controlled or independently controlled. In an arrangement whereby the first feed bar set 110 and the second feed bar set 115 are independently controlled, both the feed bar sets 110 and 115 may be engaged after a full stroke, and then the fully forward set may be disengaged to ensure that the trays 105 are captured and handed over to the next set. It will also be appreciated that in such an arrangement, both the feed bar sets 110 and 115 may be fully disengaged to clear the tray area 105 if there is a failure in the confectionery moulding machine for whatever reason.

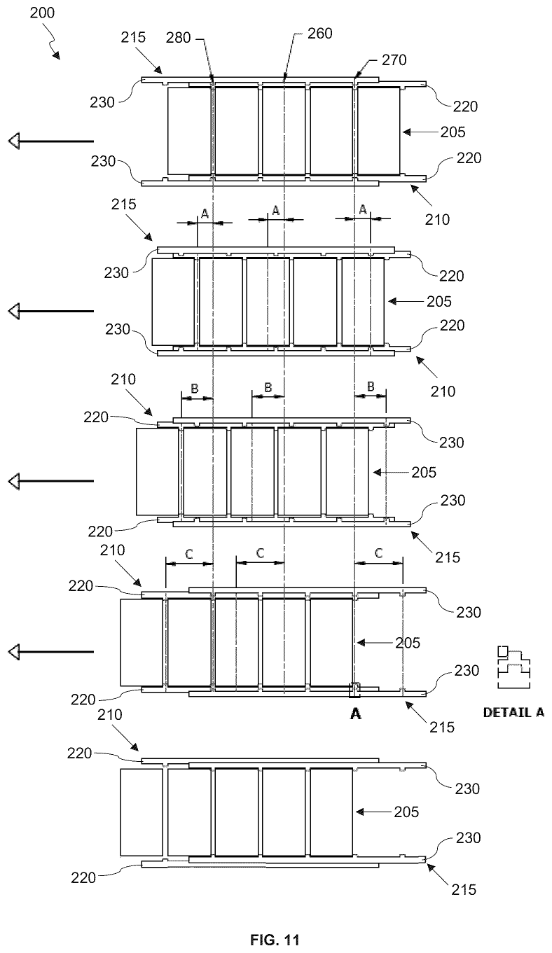

In FIG. 11 of the accompanying drawings, there is schematically depicted another embodiment of a feed bar assembly or system 200 for a confectionery moulding machine. It will be understood that the feed bar assembly 200 operates in a generally similar manner as the feed bar assembly 100 described above, with like reference numerals being used to indicate like features. It will further be understood that one or more features or functions of the embodiment of the feed bar assembly 100 described above are applicable to the embodiment of the feed bar assembly 200, and vice versa.

In this embodiment, the feed bar assembly 200 is located at the side(s) of the trays 205 so as to engage the trays 205 from the side. It will be understood that the first and second feed bar sets 210 and 215 of the feed bar assembly 200 may have a similar movement profile as that of the first and second feed bar sets 110 and 115 of the feed bar assembly 100 described above. As will be discussed in further detail below, the one of the feed bar sets 210 or 215 may engage the trays as the other of the feed bar sets 210 or 215 may disengage the trays. The engaged feed bar set may then push the trays forward a full stroke, and the disengaged feed bar set may move the same distance in the opposite direction and the feed bar sets 210 and 215 may realign. Simultaneously, the engaged feed bar set may disengage, and the disengaged feed bar set may reengage. The movement of the first and second feed bar sets 210, 215 (for example, towards and away from the centre line) may be facilitated by a feed bar mover (not shown), which may be controlled to drive the movement of the first and second feed bar sets 210, 215 simultaneously or independently. It will be appreciated that an arrangement whereby the feed bar sets 210 and 215 engage the sides of the trays may at least allow for the feed bar assembly 200 to be existing systems, and in particular, systems that are the industry standard way to demould confectionery products.

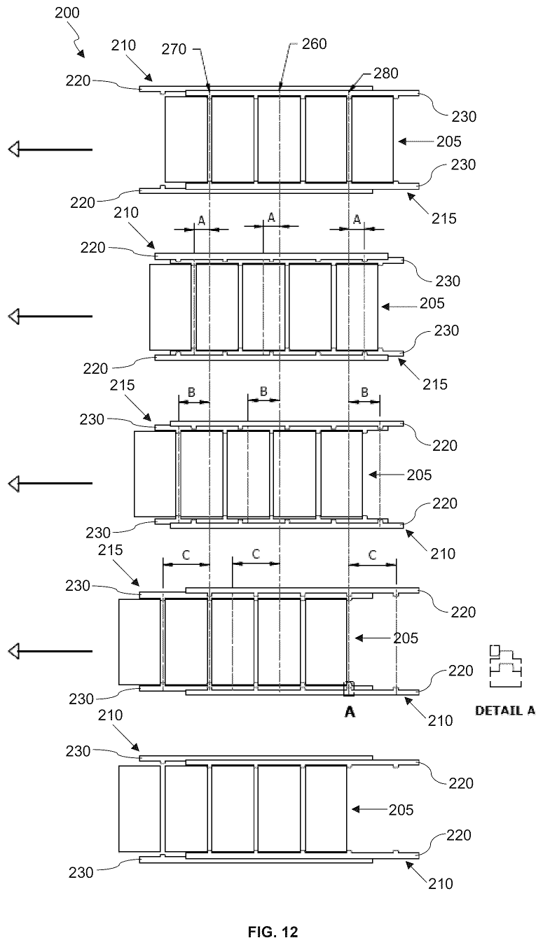

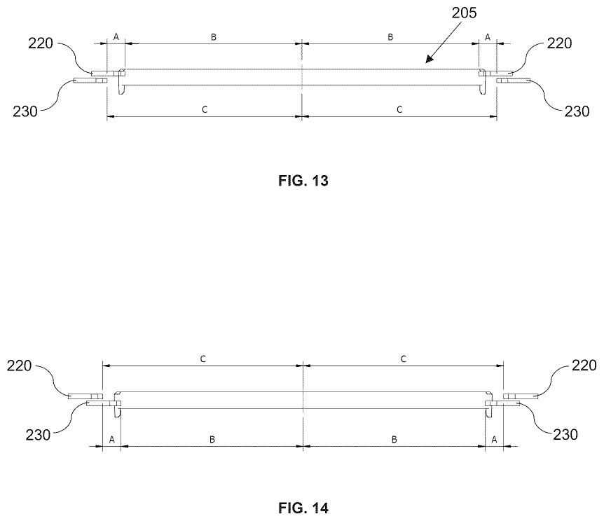

In this embodiment, in the first full stroke as shown in FIG. 11, the first feed bar set 210 engages the trays 205 and moves in a first direction from a start position to an end position in a direction indicated by arrow 260. In FIG. 11, this first direction is from the right to the left, although it will be understood that this first direction may also be considered a forward direction. It will be understood that the trays 205 move with the first feed bar set 210 during this first full stroke. Conversely, in this first full stroke as shown in FIG. 11, the second feed bar set 215 (which is positioned further away from the centre line relative to the first feed bar set 210 and thus not engaging the trays) is shown to move in a second direction that is opposite to the first direction. In FIG. 11, this second direction is from the left to the right although it will be understood that this first direction may also be considered a rearward direction. It will be understood that the first feed bar set 210 moves in the first direction at a distance that corresponds to a distance at which the second feed bar set 215 moves in the second direction. In other words, upon the completion of the first full stroke as shown in FIG. 11, the first feed bar set 210 has moved from right to left along the same distance/rate that the second feed bar set 215 has moved from left to right. This distance may correspond to a length of a tray and a gap between the trays. In FIGS. 11 and 12, a tray reference line 265 is shown, along with a reference line 270 for the first feed bar set 210 and a reference line 275 for the second feed bar set 215. The reference lines 265, 270, and 275 provide a visual indication of the relative distances A, B, and C during various stages of the first full stroke.

Following the completion of the first full stroke as shown in FIG. 11, the feed bar lugs 225 of the first feed bar set 210 and the feed bar lugs 235 of the second feed bar set 215 are aligned (see, for example, Detail A as shown in FIG. 11). Following the completion of the first full stroke, the first feed bar set 210 is shown to be in the end position whilst the second feed bar set 215 is in a position that corresponds to the start position of the first feed bar set 210. The second full stroke may commence immediately after the first full stroke.

In the second full stroke as shown in FIG. 12, the feed bar mover is controlled or actuated to move the first feed bar set 210 away from the centre line and to the move the second feed bar set 215 towards the centre line, whereby the first feed bar set 210 disengages the trays 205 and the second feed bar set 215 engages the trays 205. The second feed bar set 215 moves in the first direction from a start position to an end position. As discussed above, this first direction is from the right to the left in the Figures, although it will be understood that this first direction may also be considered a forward direction. It will be understood that the trays 205 move with the second feed bar set 215 during this first full stroke. Conversely, in this second full stroke as shown in FIG. 12, the first feed bar set 210 (which is positioned further away from the centre line relative to the second feed bar set 215 and thus not engaging the trays) is shown to move in the second direction that is opposite to the first direction. As discussed above, this second direction is from the left to the right in the Figures, although it will be understood that this first direction may also be considered a rearward direction. As with the first full stroke discussed above, it will be understood that in the second full stroke, the second feed bar set 215 moves in the first direction at a distance that corresponds to a distance at which the first feed bar set 210 moves in the second direction. In other words, upon the completion of the second full stroke as shown in FIG. 12, the second feed bar set 215 has moved from right to left along the same distance/rate that the first feed bar set 210 has moved from left to right.

Following the completion of the second full stroke as shown in FIG. 12, the feed bar lugs 225 of the first feed bar set 210 and the feed bar lugs 235 of the second feed bar set 215 are aligned (see, for example, Detail A as shown in FIG. 12). The feed bar mover may then be controlled to move the second feed bar set 215 away from the centre line and the first feed bar set 210 towards the centre line, whereby the first full stroke as shown in FIG. 11 may commence again to continue the movement profile of the feed bar assembly 200.

As discussed above in relation to the feed bar assembly 100, is envisaged that the movement of the first feed bar set 210 and the second feed bar set 215 towards and away from the centre line may either be simultaneously controlled or independently controlled. In an arrangement whereby the first feed bar set 210 and the second feed bar set 215 are independently controlled, both the feed bar sets 210 and 215 may be engaged after a full stroke, and then the fully forward set may be disengaged to ensure that the trays 205 are captured and handed over to the next set. It will also be appreciated that in such an arrangement, both the feed bar sets 210 and 215 may be fully disengaged to clear the tray area 205 if there is a failure in the confectionery moulding machine for whatever reason.

It will thus be appreciated that, in the exemplary arrangement of the feed bar assembly 100 described above, one of the feed bar sets (e.g. the first feed bar set 110) moves in a first (e.g. forward) direction to push the trays 105, and then at the end of the stroke, the other feed bar set (e.g. the second feed bar set 115) is ready to engage the trays 105 and repeat the movement in the forward direction. This arrangement may at least effectively halve the work done per stroke (i.e. by removing the need for a single feed bar set to quickly and aggressively return backwards to prepare for the next cycle), and may thus allow for a gentler and more efficient transport of the trays 105 throughout the confectionery moulding machine. It will be appreciated that this arrangement may also allow for a more precise/accurate and gentler engagement of the trays 105, thereby limiting the vibrations and shocks/jerks in movement that can cause cracks in the moulded shapes in the starch. Because of improved tray control/the reduction in starch cracking, the confectionery moulding machine can operate more efficiently/faster (i.e. to accommodate a higher number of trays per minute) which may at least increase the production rate.

Although specific embodiments of the invention are illustrated and described herein, it will be appreciated by those of ordinary skill in the art that a variety of alternative and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, etc. are used merely as labels, and are not intended to impose numerical requirements on or to establish a certain ranking of importance of their objects.

1. A feed bar assembly for a confectionery moulding machine, the feed bar assembly including:
a first feed bar set having a pair of elongated feed bars, with each elongated feed bar including a plurality of lugs, the first feed bar set being moveable between a raised position to engage one or more confectionery moulding trays and a lowered position to disengage from the one or more confectionery moulding trays;
a second feed bar set having a pair of elongated feed bars, with each elongated feed bar including a plurality of lugs, the second feed bar set being moveable between a raised position to engage one or more confectionery moulding trays and a lowered position to disengage from the one or more confectionery moulding trays;
a feed bar lift adapted to move the first and second feed bar sets between the respective raised and lowered positions.

2. The feed bar assembly according to claim 1, wherein the feed bar lift moves the first feed bar set from the lowered position to the raised position whilst simultaneously moving the second feed bar set from the raised position to the lowered position.

3. The feed bar assembly according to claim 1, wherein the first feed bar set is movable in a first direction from a start position to an end position to complete a first full stroke.

4. The feed bar assembly according to claim 3, wherein the second feed bar set is movable in a second direction that is opposite to the first direction.

5. The feed bar assembly according to claim 4, wherein the first feed bar set is movable at a distance that corresponds to a distance at which the second feed bar set moves.

6. The feed bar assembly according to claim 3, wherein the first feed bar set is lowered following the completion of the first full stroke whilst the second feed bar set is raised.

7. The feed bar assembly according to claim 3, the second feed bar set is movable in a first direction from a start position to an end position to complete a second full stroke.

8. The feed bar assembly according to claim 7, wherein the first feed bar set is movable in a second direction that is opposite to the first direction.

9. The feed bar assembly according to claim 9, wherein the second feed bar set is movable at a distance that corresponds to a distance at which the first feed bar set moves.

10. The feed bar assembly according to claim 7, wherein the second feed bar set is lowered following the completion of the second full stroke whilst the first feed bar set is raised to commence the first full stroke to continue a movement profile of the feed bar assembly.

11. The feed bar assembly according to claim 1, wherein the first and second feed bar sets are locatable below the one or more confectionery moulding trays of the confectionery moulding machine.

12. The feed bar assembly according to claim 1, wherein the first feed bar set is locatable at a first side of the one or more confectionery moulding trays and the second feed bar set is locatable at a second side of the one or more confectionery moulding trays.

13. The feed bar assembly according to claim 1, wherein the first and second feed bar sets are locatable above the one or more confectionery moulding trays of the confectionery moulding machine.

14. A method of operating a feed bar assembly for a confectionery moulding machine, the feed bar assembly including a first feed bar set and a second feed bar set, the method including the steps of:
moving the first feed bar set from a lowered position to a raised position to engage one or more confectionery moulding trays whilst simultaneously moving the second feed bar set from a raised position to a lowered position;
moving the first feed bar set in a first direction from a start position to an end position to complete a first full stroke;
moving the first feed bar set from the raised position to the lowered position to disengage the one or more confectionery moulding trays whilst simultaneously moving the second feed bar set from a lowered position to a raised position to engage one or more of the confectionery moulding trays; and
moving the second feed bar set in the first direction from a start position to an end position to complete a second full stroke.

15. A feed bar assembly for a confectionery moulding machine, the feed bar assembly including:
a first feed bar set having a pair of elongated feed bars, with each elongated feed bar including a plurality of lugs, the first feed bar set being moveable between a first position to engage one or more confectionery moulding trays and a second position to disengage from the one or more confectionery moulding trays;
a second feed bar set having a pair of elongated feed bars, with each elongated feed bar including a plurality of lugs, the second feed bar set being moveable between a first position to engage one or more confectionery moulding trays and a second position to disengage from the one or more confectionery moulding trays;
a feed bar mover adapted to move the first and second feed bar sets between the respective first and second positions.

16. The feed bar assembly according to claim 15, wherein in the first position, the feed bars of the first feed bar set are closer to a tray line relative to the feed bars of the second feed bar set and in the second position, the feed bars of the second feed bar set are closer to the tray line relative to the feed bars of the first feed bar set.

17. The feed bar assembly according to claim 16, wherein the feed bar mover moves the first feed bar set from the second position to the first position whilst simultaneously moving the second feed bar set from the first position to the second position.
